(19) United States
(12) Patent Application Publication
(10) Pub. No.: US 2014/0067448 A1
(43) Pub. Date: Mar. 6, 2014

(54) SYSTEM AND METHOD FOR COMPLIANCE EVENT AND INCIDENT MANAGEMENT (CEIM)

(71) Applicants: Arushi Sood Joshi, Cupertino, CA (US); Pablo Fernández Montes, Sevilla (ES); Manuel Resinas Arias de Reyna, Sevilla (ES); Antonio Ruíz Cortés, Santiponce (ES)

(72) Inventors: Arushi Sood Joshi, Cupertino, CA (US); Pablo Fernández Montes, Sevilla (ES); Manuel Resinas Arias de Reyna, Sevilla (ES); Antonio Ruíz Cortés, Santiponce (ES)

(73) Assignee: Unidash, Inc., Cupertino, CA (US)

(21) Appl. No.: 13/602,291

(22) Filed: Sep. 3, 2012

(51) Int. Cl. G06Q 10/00

(52) U.S. Cl. 705/7.12; 705/7.11; 705/317

(57) ABSTRACT

Provided is a system and method for a continuous event and incident management approach to regulatory and compliance management, and business process management.

### INTRODUCTION

The present disclosure is directed generally to a system and method for a continuous event and incident management (CEIM) approach to regulatory and compliance management, and business process management.

More particularly, the present disclosure is directed generally to a compliance and governance system. More specifically, it relates to a continuous compliance and process event and compliance incidence management system. It is used for managing compliance and processes for enterprises and can be hosted internally or in the cloud or in the managed hosting environment. It includes the notification of compliance failures and compliance breaches to business units and customers and third parties including government regulatory agencies.

Organizations are subject to significant compliance requirements by governments and third parties. These requirements imply continuous compliance and not a point-in-time compliance against a regulation or standard or requirement.

In order to comply with most regulations and process requirements there are two general requirements. The first is the ability of an organization to follow good processes with strong controls on a consistent and continuous basis. The second is the ability of an organization to know when those processes and controls have been breached or have failed and trigger appropriate actions in meeting its regulatory, fiduciary, and moral responsibilities.

However, many organizations face challenges in achieving the first requirement of continuous compliance or accessing the quality of their processes on an on-going basis. Many of the activities and tasks have interdependencies. Since processes and systems change in organizations frequently, the interdependencies of other activities may be neglected leading to non-compliance. In addition, most of the systems today are point in time compliance systems. They require annual or biannual or periodic assessments or certifications. Often this is followed by a third-party audit or verification by a qualified auditor. These are generally self-assessment systems with some component of document and workflow management. However, there are significant challenges that organizations face in ensuring year round compliance and in the ability to provide evidences of processes and controls to these auditing third parties.

The compliance requirements sometimes include the mandate to inform specific parties including customers, government entities, and other related entities in case a breach or violation has occurred. The notification requirements differ by entity and type of breach that has occurred. This triggers a need for the second requirement, the requirement of notification. This need applies to all organizations that are subject to regulatory requirements within their industry. This concept also applies to regulatory notifications to other relevant stakeholders including but not limited to business units, partners etc. Within the cloud environment this requirement may apply to cloud providers that include SaaS (Software as a Service), Paas (Platform as a Service) and laas (Infrastructure as a Service) providers.

### SUMMARY

Various embodiments of the present disclosure are directed generally to a system and method that addresses the deficiencies in the art in respect to providing real time and near real time compliance facilitation to organizations and the ability of organizations to respond to compliance violations in a timely manner. It provides ability to continuously manage the required mandates from regulations and or processes. It provides a novel and non-obvious method, system and apparatus for performing real-time and near real-time management and review of the state of compliance, and the state of processes.

In one embodiment, a system is provided for managing process and regulatory compliance through a task driven engine, which is based on task patterns. The task patterns are achieved through a specification patternization process and stored in a task pattern registry. The patterns are applied to processes through a process constructor that takes input from regulations and/or standards parameters and the roles and responsibilities index.

In one embodiment, inputs into the patternization include standards, regulatory and compliance specifications, process specifications, notification regulations, and audit reporting instructions. These create the regulation parameters that processes must comply with. These patterns can be applied to any regulation. For example within PCI DSS, which is Payment Card Industry-Data Security Standards, we have applied different patterns that will then result in relevant tasks to the user.

In one embodiment, the roles and responsibilities index maps roles based on process and regulatory requirements. When the system is deployed, the roles within an organization are mapped to this role and responsibilities index. Once roles are mapped to the index, tasks are filtered based on role assignments. Where multiple individuals have the same role, the tasks are assigned to the first person that takes responsibility for it. The tasks follow an escalation and super escalation route. Escalation is based on the time of competition and risk indicators for the task.

In one embodiment, once the specification patternization process is complete, machine processable processes are created. These processes ultimately support audit processes, notification processes and compliance processes. This is achieved once the system is deployed (deployed runtime compliance and notification system). Based on the machine processable processes, specific processes are created for an organization. The processes are fed into a process engine that feeds specific tasks to the task manager in order to achieve compliance to the said regulation parameters.

In one embodiment, evidencing is captured through a unique recording system that capture the evidence of tasks being performed for auditors, internal review, and other resources. Images are captured as compressed photo files.

In one embodiment, tasks are presented to the user based on four general triggers namely time based triggers, environment change triggers, system event conversion triggers, and data dependencies triggers.

In one embodiment, there is also a third party notification system. This system is set up based on our concept of notification agreements. For example regulatory notification agreements can be set up between business units or third party vendors. Based on our unique system, obligations to third parties such as government entities can be triggered based on configuration rules. These could include parameters such as what States (example CA, MA, NJ etc.) the enterprise conducts business in, as well as obligations specific to the enterprise's Vertical (e.g., Financial services, Retail, Utilities etc.)

Additional aspects of the system and method for compliance event and incident management will be set forth in the parts that follow, or may be learned by practice of the disclosed systems and methods. In one embodiment, the systems and methods may be realized by means of the elements and combinations proposed in the claims. It is to be understood that both the foregoing general description and the detailed description below are exemplary and explanatory only and are not restrictive of the appended claims.

In one embodiment, a compliance system made with a scalable architecture is provided. In order to create a deployed runtime instance of the compliance and notification system two discrete methods are undertaken. The first is a specification patternization process and the second is a regulatory notification management process. These and other embodiments will now be described with particularity with reference to the accompanying drawings.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

In one or more various aspects, related systems include but are not limited to circuitry and/or programming for effecting herein-referenced method aspects; the circuitry and/or programming can be virtually any combination of hardware, software, and/or firmware configured to effect the herein-referenced method aspects depending upon the design choices of the system designer. In addition to the foregoing, various other method and/or system aspects are set forth and described in the teachings such as text (e.g., claims and/or detailed description) and/or drawings of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### FIGURES

The novel features of the embodiments described herein are set forth with particularity in the appended claims. The embodiments, however, both as to organization and methods of operation may be better understood by reference to the following description, taken in conjunction with the accompanying drawings as follows.

FIG. 1 illustrates a high-level system architecture according to one embodiment.

FIG. 2 illustrates a detail view of a specification patternization architecture according to one embodiment.

FIG. 3 illustrates a specification patternization workflow process according to one embodiment.

FIG. 4 illustrates a regulatory notification management system according to one embodiment.

FIG. 5 illustrates a regulatory notification management workflow process according to one embodiment.

FIG. 6 illustrates a view of a deployed runtime compliance and notification system according to one embodiment.

FIG. 7 illustrates a view of a deployed runtime compliance and notification system workflow process according to one embodiment.

FIG. 8 illustrates a view of the deployed runtime compliance and notification system role mapping workflow process according to one embodiment.

FIG. 9 illustrates an evidencing workflow process according to one embodiment.

FIG. 10 illustrates a deployed runtime compliance and notification system workflow process according to one embodiment.

FIG. 11 illustrates a data structure configuration system according to one embodiment.

FIG. 12 illustrates a high level view of an event compliance correlation system according to one embodiment.

### DESCRIPTION

Before explaining the various embodiments of the system and method for compliance event and incident management in detail, it should be noted that the various embodiments disclosed herein are not limited in their application or use to the details of construction and arrangement of parts illustrated in the accompanying drawings and description. Rather, the disclosed embodiments may be positioned or incorporated in other embodiments, variations and modifications thereof, and may be practiced or carried out in various ways. Accordingly, embodiments of the system and method for compliance event and incident management disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

In the following description, reference is made to the accompanying drawings, which form a part hereof. In the drawings, similar symbols typically identify similar components, unless context dictates otherwise. The illustrative embodiments described in the description, drawings, and claims are not meant to be limiting. Other embodiments may be utilized, and other changes may be made, without departing from the scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or Java or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electronic systems having a wide range of electrical components such as hardware, software, firmware, and/or virtually any combination thereof; and a wide range of components. Consequently, as used herein “electronic system” includes, but is not limited to, electrical circuitry, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electronic systems may include, but are not limited to, a variety of consumer electronics systems, medical devices, as well as other systems such as motorized transport systems, factory automation systems, security systems, financial systems, regulatory systems, and/or communication/computing systems.

Those skilled in the art will further recognize that at least a portion of the devices and/or processes described herein can be integrated into a computer processing system. A typical computer processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops. A computer processing system may be implemented utilizing suitable commercially available components.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

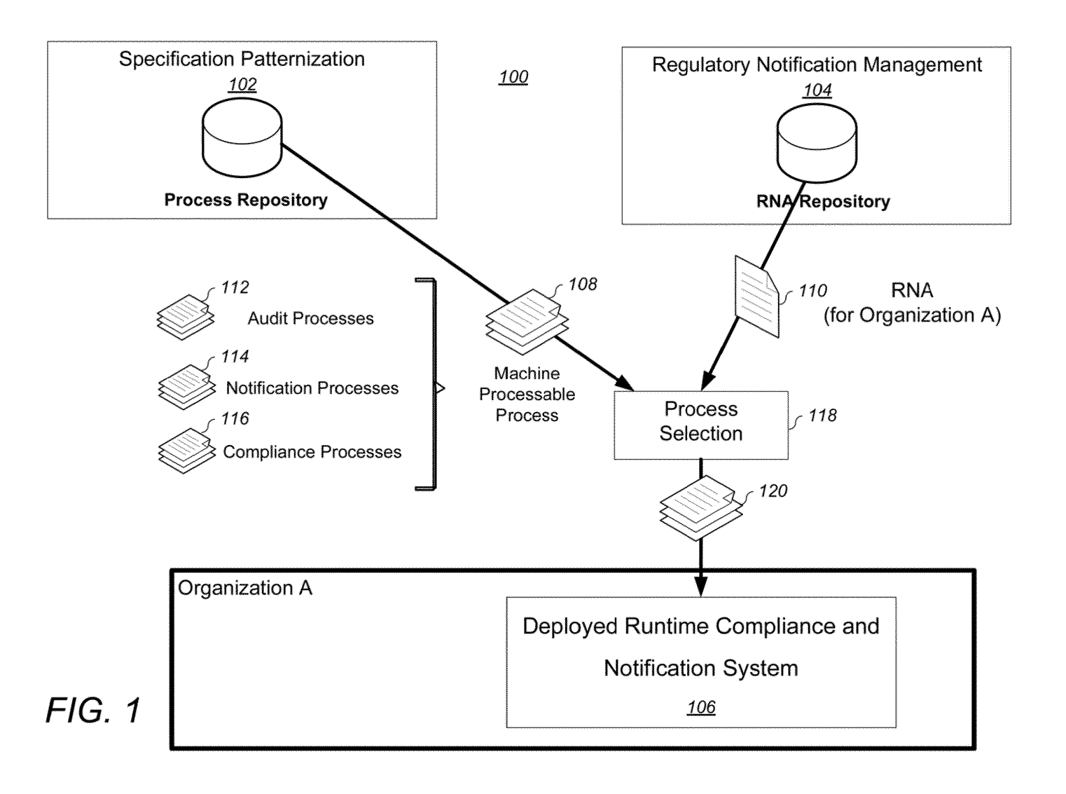

FIG. 1 illustrates a high-level system architecture 100 according to one embodiment. The high-level system architecture 100 provides a summary of a specification patternization process 102, and a regulatory notification management process 104. The specification patternization process 102 and the regulatory notification management process 104 drive the deployment of a deployed runtime compliance and notification system 106.

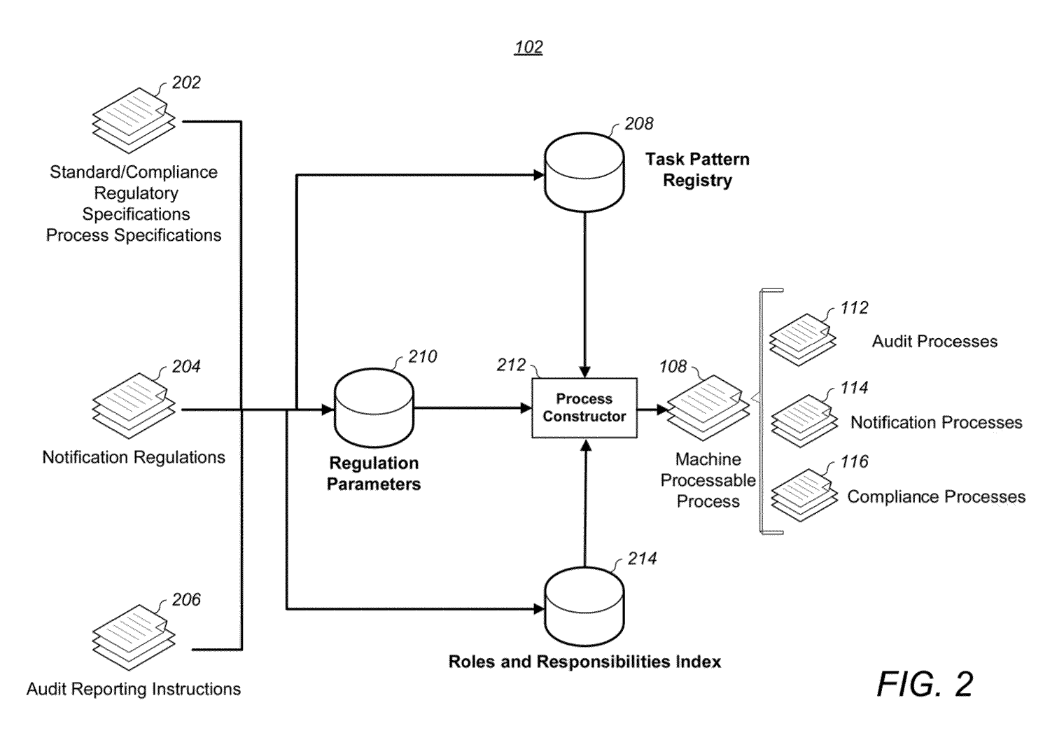

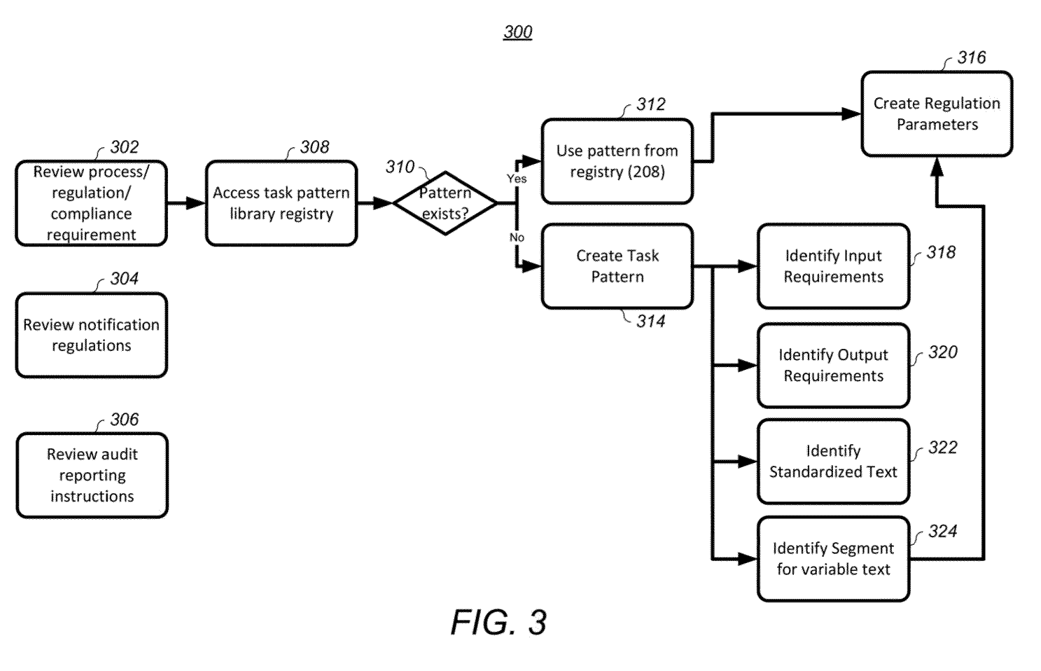

Machine readable processes 108 are generated by the specification patternization process 102 and regulatory notification agreements 110 (RNA), that are used to inform external customers such as cloud customers, SaaS customers, vendors, suppliers etc., or internal customers such as business units or employees, are proposed by the notification system 104. The machine readable processes 108 include, but are not limited to, for example, audit processes 112, notification processes 114, and compliance processes 116. The machine readable processes 108 and the RNA 110 are provided to a selection process 118. The output 120 of the selection process 118 is provided to deployed runtime compliance and notification system 106. The specification patternization process 102 is described in more detail hereinbelow with reference to FIGS. 2 and 3.

FIG. 2 illustrates a detail view of the specification patternization architecture 102 according to one embodiment. The first step of the process is to create specific patterns for the different requirements. As illustrated in FIG. 2, the specification patternization architecture 102, the process takes as input three different elements, specifications or regulations 202, notification regulations 204 requirements (State based), and audit reporting instructions 206. The specifications or regulations 202 could include process specifications, or specifications from regulations such as Payment Card Industry Data Security Standard (PCI DSS), Sarbanes Oxley (SOX), etc. The notification regulations 204 may comprise for example of State-wide reporting requirements, such as notifications for privacy breaches etc. The audit reporting instructions 206 are specific requirements that the process or regulation calls for or implies in order to meet audit obligations or the spirit of compliance.

This is further illustrated in a view of the dynamic process shown in FIG. 3, the specification patternization process 300. The specification patternization process 300 illustrates how the specifications or regulations 202, the notification regulations 204 requirements (State based), and the audit reporting instructions 206 are reviewed as inputs. The three regulations 202, notification regulations 204 requirements (State based), and audit reporting instructions 206 inputs sometimes will create new task patterns, and sometimes they will use existing task patterns based on a library of already created task patterns stores in the task pattern registry 208, as shown in FIG. 2.

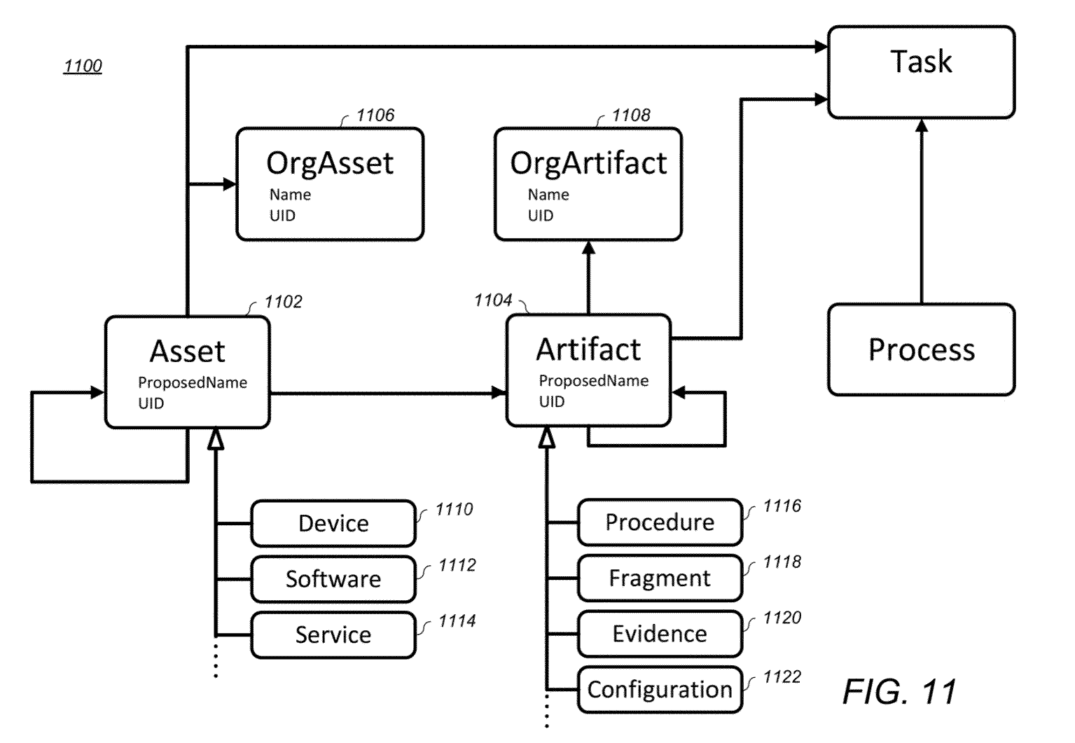

As shown in FIG. 3, the task patterns are structured with predefined information with segments of the pattern changing based on the task. The patterns provide the input needed to complete the tasks. The inputs are in the form of one or both elements in the data structure 1008 as outlined in FIG. 11, for example. The data structures 1008 in the engine are defined into assets 1102 and artifacts 1104. The task patterns will have the data structures 1008 as inputs and outputs.

Once a task pattern has been detected or created 314, the process of creating regulation parameters 316 is initiated. The regulation parameters are a general name used to refer to the inputs, outputs, standard text, and variable text that create the parameterized task pattern for a specific requirement. In essence, for each requirement there will be a set of task patterns, and for each task pattern there will be a set of parameters.

With reference back to FIG. 2, the tasks are linked together with a certain structure to create the flow of tasks. A process constructor 212 is responsible for creating the process and linking the flow of tasks. Process parameters within the process constructor 212 orchestrate the sequence of the tasks to create a process. The sequence may be parallel, random, sets of tasks, or loops among others. The process constructor 212 uses as inputs the created regulation parameters 210, and task patterns 208 to create processes that satisfy the requirements within the regulations.

The requirements of the specifications are analyzed and the different responsibilities assigned depending on the type of the elements involved. Classification of tasks is based on roles and responsibilities index 214.

The machine processable processes 108 are generated as an output of the process constructor in order to build the process that houses the formal definition of the process and tasks involved. As an output a set of artifacts are created which will include different business process modeling notation (BPMN) or other format files that define the process. Different processes are triggered from the BPMN or other format files based on the input specification or instructions as outlined in the specifications or regulations 202, the notification regulations 204 requirements (State based), and the audit reporting instructions 206. For example, where compliance specifications 202 are used as an input, the system derives a set of BPMN files that articulate the compliance processes 116 over the specification. For the notification regulations 204 requirements, a BPMN notification processes 114 is created, and for the audit reporting instructions 206, a BPMN audit reporting processes 112 are created.

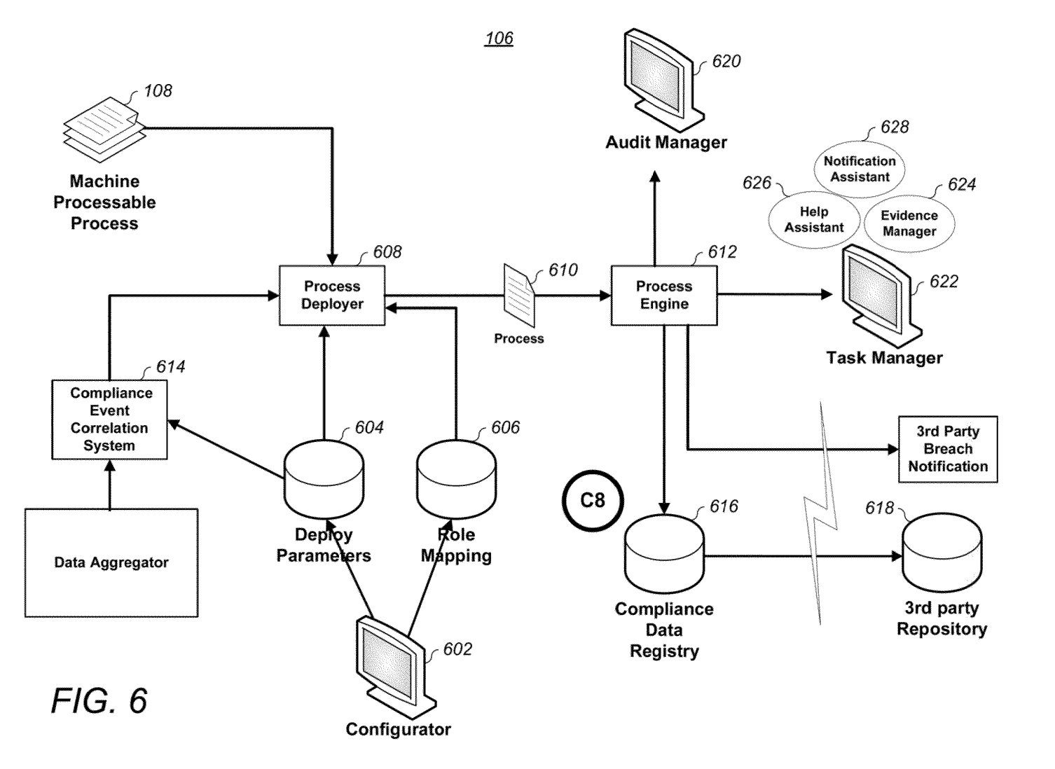

In one embodiment of the system, the format BPMN is used. However, other formats may be used as well. The BPMN or other format files are fed into a process engine 612, as shown in FIG. 6, for example, that will be responsible for the execution or orchestration of the process when combined with the other system elements.

FIG. 3 illustrates a specification patternization workflow process 300 according to one embodiment. The specification patternization workflow process 300 reviews the process/regulation/compliance requirement 302, the notification regulations 304, and/or the audit reporting instructions 306. The process 300 then accesses 308 the task pattern library registry 208 (FIG. 2) and determines 310 whether a pattern exists. If a pattern exists, the process 300 continues along the YES branch to create 316 the regulatory parameters 210 (FIG. 2). If a pattern does not exist, the process 300 continues along the NO branch to create 314 a task pattern. To create a task pattern, the process 300 may perform one or more steps. For example, in one embodiment, to create a task pattern, the process 300 identifies 318 the input requirements, identifies 320 the output requirements, identifies 322 the standardized or static elements of the pattern text and builds them into the pattern, and/or identifies 324 or defines the segments or specification for the variable or dynamic text. The dynamic text generally originates from the requirements text. As previously discussed, once the task pattern is created the process 300 creates 316 the regulation parameters 210 (FIG. 2).

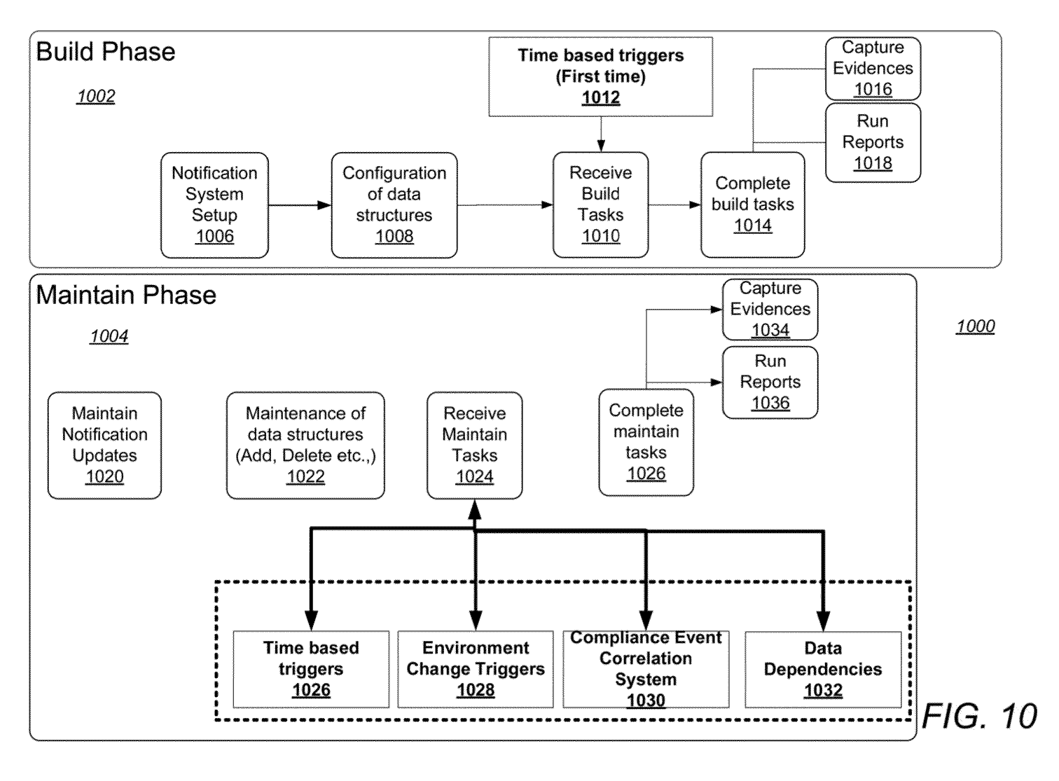

A collection of task patterns has been created and these have found to be repeatable across processes and regulatory requirements. Most task patterns have variations depending on whether they are being applied to a build or maintain phase. The build and maintain phases are described in FIG. 10.

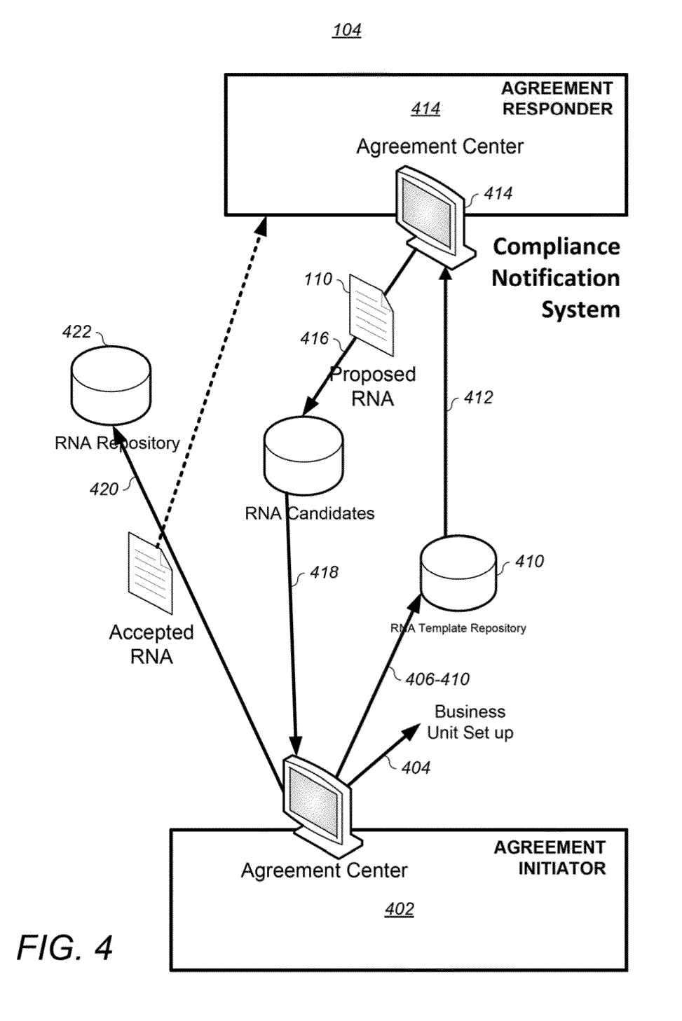

FIG. 4 illustrates a regulatory notification management system 104 according to one embodiment. As previously stated, the notification system 104 proposes the concept of regulatory notification agreements 110 (RNA) (FIG. 1) that are used to inform external customers such as cloud customers, SaaS customers, vendors, suppliers etc., or internal customers such as business units or employees. The same method and system could be applied to a single enterprise without any third party notification requirements.

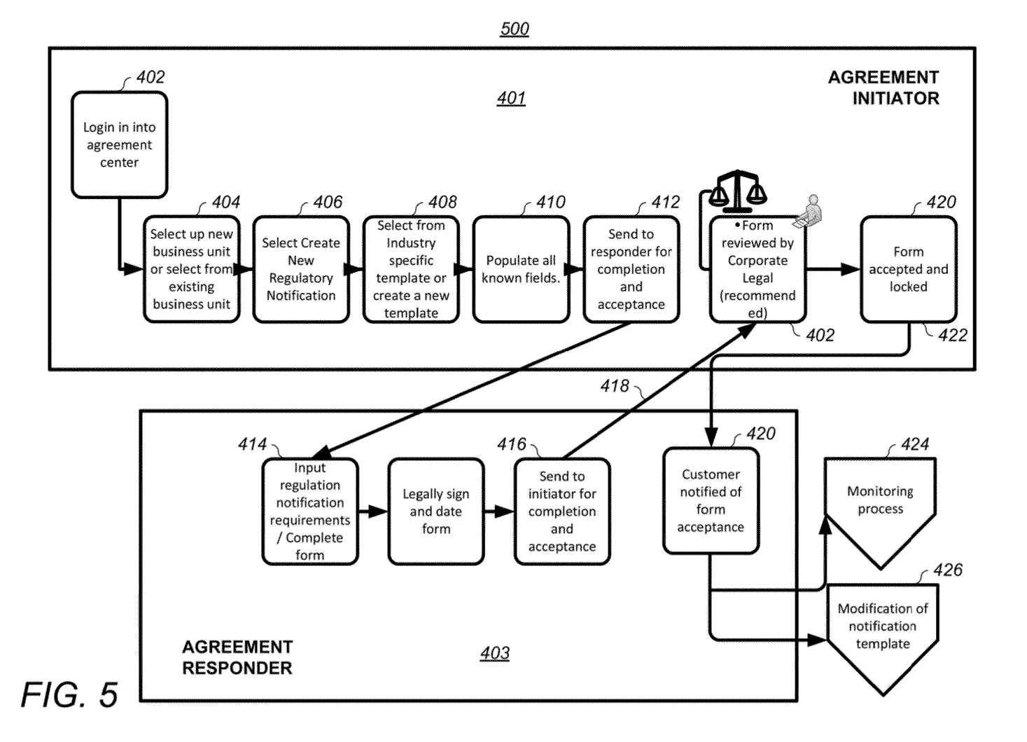

FIG. 5 illustrates a regulatory notification management workflow process 500 according to one embodiment. FIG. 5 provides a workflow-based view of the notification system 104 shown in FIG. 4. Reference numbers in FIGS. 4 and 5 typically identify similar components, unless context dictates otherwise, and are consistent showing the same activities from different perspectives. The following description applies to both the regulatory notification management system 104 and the regulatory notification management workflow process 500 shown in FIGS. 4 and 5.

Accordingly, with reference now to FIGS. 4 and 5, in one embodiment, the agreement center 402 is the management console of the agreements for the agreement initiator 401 generally the service provider or corporate business unit or variations thereof (referred to as agreement initiator 401 for description of the embodiments). The agreement initiator 401 initiates the set up of the business unit 404. Either during business unit set up 404 or separately, the agreement initiator 401 creates a regulatory notification agreement. A new regulatory notification agreement 406 can be initiated. At block 408, the agreement can be created by selecting from industry specific templates, creating a new template, or by selecting from predefined templates. The RNA template repository 410 contains standard notification templates. The templates could represent different regulations such as Sarbanes Oxley, HIPAA, PCI etc., or different business processes such as accounting, security, order to cash, procure to pay etc. These templates contain associated information related to the industry, process, regulation or project. They also contain the notification frequency and reporting detail. Agreements can also be created without the templates. At block 410, the initiator completes the agreement template and sends it to an agreement responder 403 for completion and acceptance as indicated in block 412. The agreement responder 403 is generally the customer with whom the initiator intends to enter into this RNA.

The customer reviews this agreement using the agreement center 414 that is the management console of the agreements for the provider. Once the provider assigns required responsibilities, and agrees to other parameters the proposed RNA 416 is sent to the initiator. This agreement could essentially be an acceptance of the agreement as sent by the initiator, or it could contain changes proposed by the agreement responder 403. The RNA candidate is sent to the initiator within 418.

The initiator uses resources within the agreement center 402 to review and access the RNA candidate. If the RNA is acceptable, the RNA is reviewed by legal personnel at block 402 explicitly agreeing to the terms. The locked and final agreement 420 is sent to an RNA repository 422 that contains the details by which notification will be executed. If any changes are proposed in the agreement the process is iterative until an agreement is reached. The pattern remains unchanged while the communication flow to set up the notification correspondingly changes. Subsequently, the monitoring process 424 is triggered and notifications are managed based on the agreements. A modification of notification template 426 is triggered if the templates need to be modified and essentially follows the same workflow 500. In some cases, the customer instead of the provider may initiate the RNA. In such an event the steps in the regulatory notification management workflow process 500 will essentially remain unchanged with the flow of information being reversed.

FIG. 6 illustrates a view of a deployed runtime compliance and notification system 106 according to one embodiment. The specification patternization 102 and regulatory notification management 104 are essentially the fodder for the implementation and execution of the system as a deployed runtime compliance and notification system in 106. A user view of a deployed runtime compliance and notification system workflow process is illustrated in FIG. 10.

The deployed runtime compliance and notification system 106 takes as an input the set of BPMN or similar format process files that need to be run. The machine processable processes generated by the configurator 602 become the input.

The configurator 602 includes the need to define compliance deployment parameters 604 that will define the compliance road map (expected time to compliance), compliance status, and updating frequency for the recurring tasks that are needed for continuous compliance. It also will include tasks for role mapping 606, where the responsibilities are assigned the actual roles within the organization.

Once the deployments parameters 604 and the role mapping 606 are defined, the process deployer 608 will instantiate the process 610 into the process engine 612. The process deployer 608 will be responsible for selecting the BPMN file and launching it to the process engine 612. As indicated in FIG. 10, in the first phase of the system configuration within the build phase 1002 this launch or deployment of processes will be predefined. In the second phase, the maintaining phase 1004, the focus is on continuous compliance. The deployer will take into account the other events to deploy new instances of processes.

With reference now back to FIG. 6, one source will be a compliance event correlation system 614 comprising a compliance analytics engine that, taking into account the structure of the organization and feeds of data from the infrastructure, will generate compliance level events that are meaningful to the process deployer 608 and instantiate a new process into the process engine 612.

Another source of continuous process deployment will be related to data dependencies in each of the task. The compliance data registry 616 contains all information necessary or modified during a task. Each task has been defined with a specific set on inputs and outputs. If one task modifies a specific data element of the system then all tasks that relates to the same elements of the system that has changed should be reinterpreted or regenerated to react to the change of the element.

A third party repository 618 represents external systems that the deployed runtime compliance and notification system needs to interact with. It is possible that compliance data is not always in the aforementioned system. In that scenario, the system 106 will have pointers or links to the actual artifacts 1104 or assets 1102 (FIG. 11) within the organization that are maintained in an external repository.

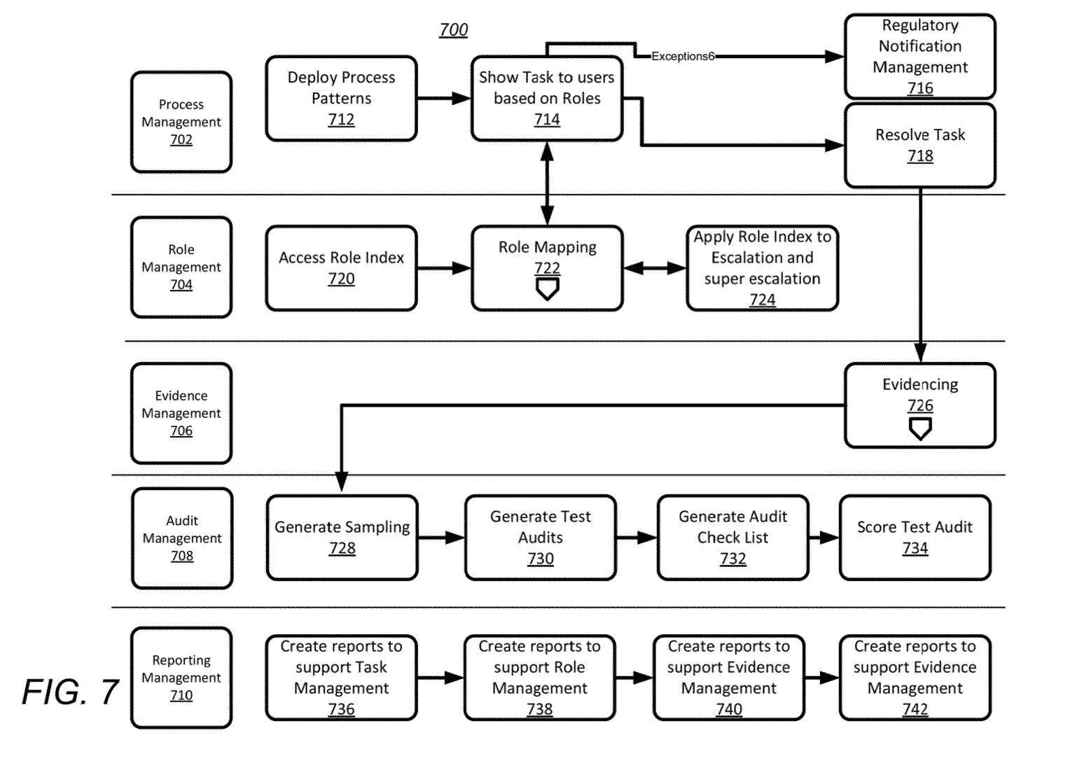

An audit manager 620 manages the requirements related to the audit reporting instructions 206 (FIGS. 1-3) and further enhanced functionality. This is further illustrated in FIG. 7, which illustrates a view of a deployed runtime compliance and notification system workflow process 700 according to one embodiment. In the audit management phase 708, sampling may be generated 728 for a set of data parameters, artifacts, and assets. When the user or the audit requirement wants to assess the performance of a task, they may not want to apply it across the entire universe of available samples. Samples are selected based on certain criteria or on a random basis. The deployed runtime compliance and notification system 106 also generates 730 test audits based on certain criteria or on a random basis to test the efficacy and performance of the quality or comprehensiveness of the task performance. An audit check list is also generated 732, and the test audits are scored 734. These will enable the user to satisfy audit requirements, conduct their own internal audits, or prepare for audits. The entire deployed runtime compliance and notification system workflow process 700 is further described hereinbelow with reference to FIG. 7.

With reference now back to FIG. 6, a task manager 622 is the receiver and conduit by which tasks are managed. Once tasks are received from the process engine 612 based on the embodiment described above they are presented to the user above with additional enhanced functionality. The deployed runtime compliance and notification system 106 essentially has three main additional functionalities. They include, without limitation, an evidence manager 624, a help assistant 626, and a notification assistant 628, for example.

The help assistant 626 provides task guideline either as a part of the task manager 622 or as a part of the evidence manager 624. Combined with the evidence manager 624 the help assistant 626 provides unique functionality to support the user in capturing evidence.

The evidence manager 624 helps to automatically generate evidence that support manual tasks, by using recording and screen shots from the individual performing the task. The help assistant 626 can be used in conjunction with the evidence manager 624. The evidence manager 624 can provide step-by-step guidance per task to provide guidance on what should be done to create the most robust evidencing recording for the task.

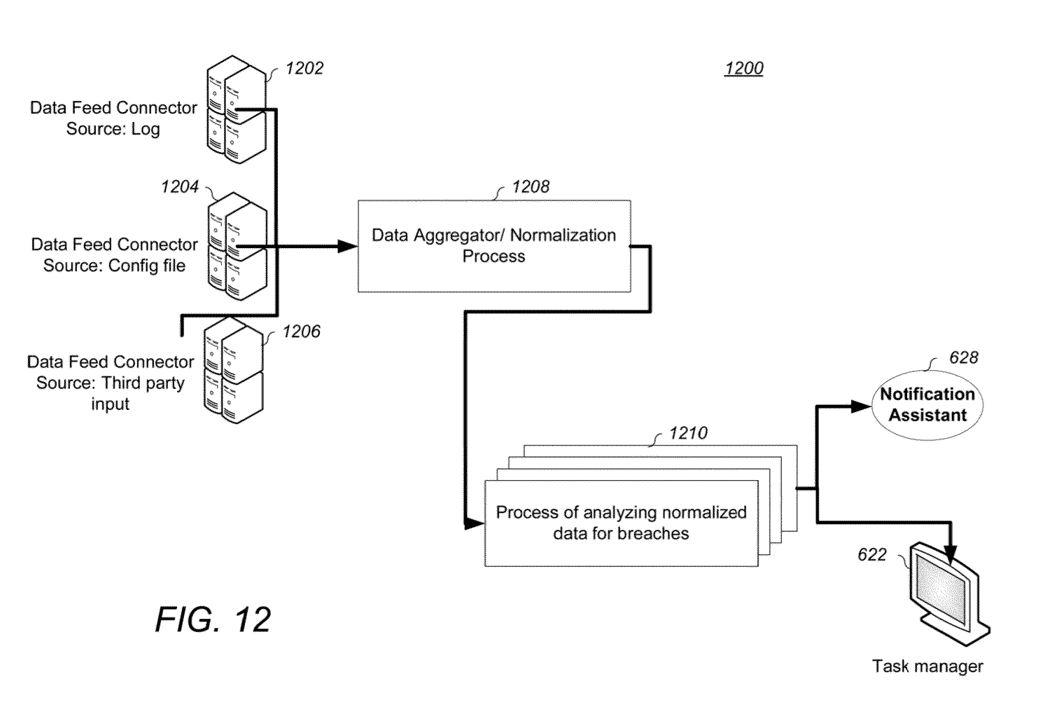

The notification assistant 628 gets activated when a specific breach is in progress. The input for the notification assistant 628 can come from various sources. They could be generated as tasks based on specification processes. They could also be identified by the user within the deployed runtime compliance and notification system 106. The breaches could also be identified by the compliance event correlation system 614 shown in more detail in FIG. 12. The notification assistant 628 will show the appropriate notification tasks generated by the specification processes or automatically by the compliance event correlation system 614. Some of the elements can be generated automatically to third party system based on approval by a human. The system 106 provides the ability for automatic breach notification as well as notification post intervention and approval.

FIG. 7 illustrates a view of a deployed runtime compliance and notification system workflow process 700 according to one embodiment. The deployed runtime compliance and notification system workflow process 700 comprises several management phases including but not limited to a process management phase 702, a role management phase 704, an evidence management phase 706, an audit management phase 708, as previously described, and a reporting management phase 710.

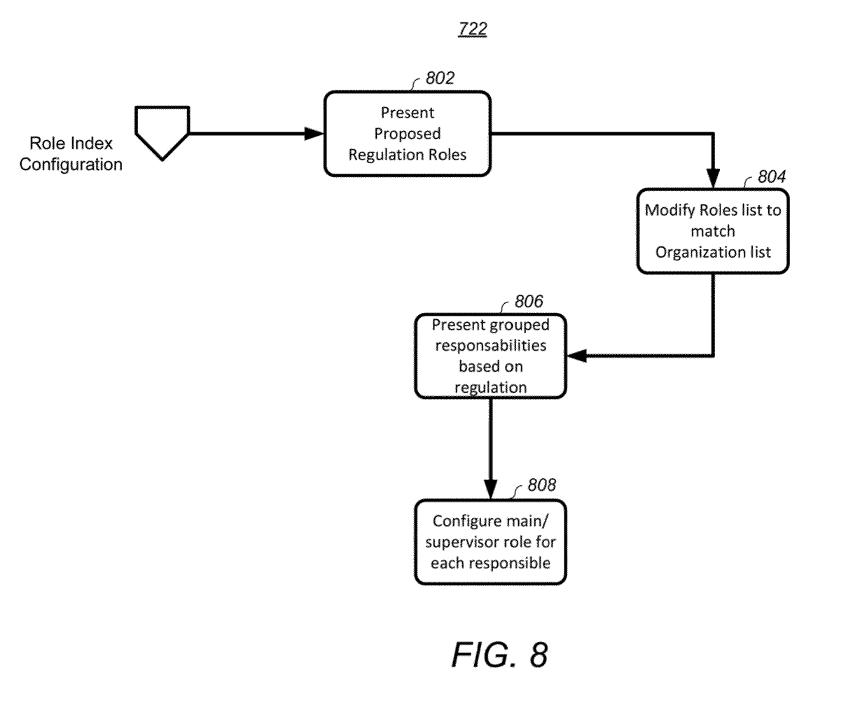

With reference now to both FIGS. 6 and 7, in the process management phase 702, the process patterns are deployed 712 by the deployed runtime compliance and notification system 106 elements 602-616. The task is shown 714 to users by the task manager 622 based on roles retrieved by a role mapping 722 process from the role mapping database 606. The role mapping 722 process is described in more detail hereinbelow with reference to FIG. 8. The tasks are managed 716 by the regulatory notification assistant 628. Tasks are resolved 718 by the help assistant 626.

Still with reference to FIGS. 6 and 7, in the role management phase 704, the role index is accessed 720 in the role mapping 722. The role index is applied 724 escalation and super escalation. The tasks for role mapping 722 from the role mapping 606 database, where the responsibilities are assigned the actual roles within the organization, are provided to the task manager 622 for display.

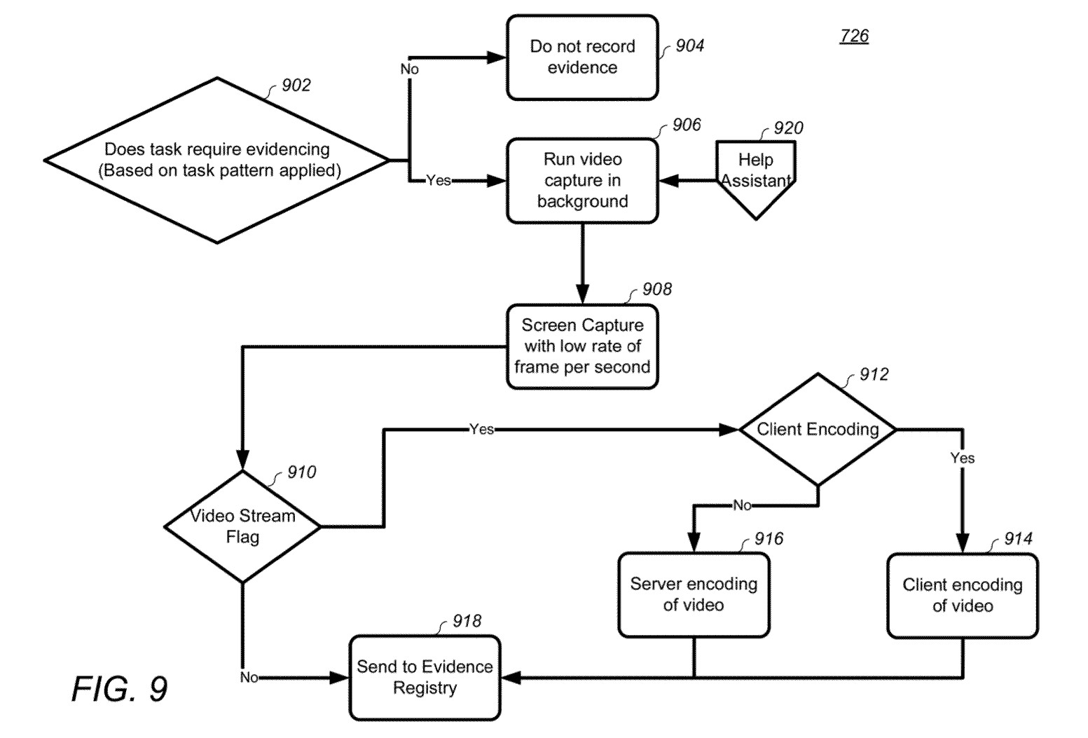

In the evidencing phase 706, the evidence manager 624 receives 726 evidencing associated with the task resolution 718 from the help assistant 626. The evidencing receiving 726 process is discussed in more detail hereinbelow with reference to FIG. 9.

Still with reference to FIGS. 6 and 7, as previously discussed, in the audit management phase 708, sampling may be generated 728 for a set of data parameters, artifacts, and assets. When the user or the audit requirement wants to assess the performance of a task, they may not want to apply it across the entire universe of available samples. Samples are selected based on certain criteria or on a random basis. The deployed runtime compliance and notification system 106 also generates 730 test audits based on certain criteria or on a random basis to test the efficacy and performance of the quality or comprehensiveness of the task performance. An audit check list is also generated 732, and the test audits are scored 734. These will enable the user to satisfy audit requirements, conduct their own internal audits, or prepare for audits.

In the reporting management phase 710, various reports are created to support task, role, evidence, and audit management phases 702-710. Reports are created 736 to support the task management. Reports are created 738 to support role management, reports are created 740 to support evidence management, and reports are created 742 to support audit management.

FIG. 8 illustrates a detailed view of the deployed runtime compliance and notification system role mapping workflow process 722, shown in FIG. 7, according to one embodiment. The role mapping process 722 presents 802 proposed regulation roles, modifies 804 roles list to match organization list, presents 806 grouped responsibilities based on regulation, and configures 808 a main/supervisor role for each responsible.

FIG. 9 illustrates an evidencing workflow process 726 according to one embodiment. Initially, the evidencing workflow process 726 determines 902 whether a task requires evidencing based on a task pattern applied. If the task does not require evidencing, the process continues along the NO path and does not record 904 evidence. If the task does require evidencing, the process continues along the YES path to run 906 video capture in the background. During the background video capture help may be received 920 from the help assistant 626 (FIG. 6). The video screens are captured 908 with a low rate of frames per second. The evidencing workflow process 726 determines 910 whether the video stream flag is set. If the video stream flag is set, the process 726 continues along the YES branch to determine 912 whether client encoding is enabled. If client encoding is enabled, the process 726 continues along the YES branch to client encoding 914 of the video and then sends 918 to evidence registry. If client encoding is not enabled, the process 726 continues along the NO branch to server encoding 916 of the video and then sends 918 to evidence registry. Back to decision block 910, if the video stream flag is not set, the process 726 continues along the NO branch to determine 912 whether client encoding is enabled and then sends 918 to evidence registry.

FIG. 10 illustrates a user view of a deployed runtime compliance and notification system workflow process 1000 according to one embodiment. There are essentially two phases within the deployed runtime compliance and notification system 106, a build phase 1002 and a maintain phase 1004. Most patterns have variations depending on whether they are being applied to the build phase 1002 or the maintain phase 1004.

In the build phase 1002 of the deployed runtime compliance and notification system workflow process 1000, the notification system is setup 1006, the data structures are configured 1008, and build tasks are received 1010 along with initial (first time) time based triggers 1012. In the build phase 1002 there is a first time configuration of data structures 1008. The time based trigger 1010 for the first configuration executes itself within the configuration process in the configurator 602 (FIG. 6). Once build tasks are completed 1014, evidence is captured 1016 and reports are run 1018.

In the maintain phase 1004 of the deployed runtime compliance and notification system workflow process 1000. The maintain phase 1004 maintains 1020 notification updates and maintains 1022 data structures. Maintain tasks are received 1024. These maintenance events can be triggered based on four general triggers namely time based triggers, environment change triggers, system event conversion triggers, and data dependencies triggers. The user of deployed runtime compliance and notification system workflow process 1000 denotes four different trigger events for the process.

The first trigger event is a time-based trigger. It has two variations, time based triggers 1012 for the first configuration of the system in the build phase 1002 and triggers 1026 related to the maintain phase of the lifecycle in the maintain phase 1004. The user can modify the time triggers 1026.

Environment change triggers 1028 represent changes that could be applied to the deployed runtime compliance and notification system 106 based on the input requirements, specifically the specifications or regulations 202, the notification regulations 204 requirements (State based), and the audit reporting instructions 206, as discussed with reference to FIGS. 1 and 2.

Data dependencies triggers 1032 correspond to the compliance data registry 616 in the description above in connection with FIG. 6.

In another embodiment, a system for interpreting trigger events 1030 from at least one other third party system that is generating trigger events is provided. This is referenced in the event compliance correlation system 614 (FIG. 6 and FIG. 10). The event compliance correlation system 614 converts events such as security events into compliance events.

FIG. 11 illustrates a data structure configuration system 1008 according to one embodiment. The data structures will be stored inside the compliance data registry as represented in the example data structure configuration system 1008 shown in FIG. 10. The data structures are grouped from the high level perspective into two different elements, assets 1102 and artifacts 1104. The assets 1102 are the elements that generate value to the organization or compose the infrastructure supporting business processes. The assets 1102 will correspond the to the different system components that are relevant to compliance. The artifacts 1104 will be a set of components that support the functionality of the assets 1102. Examples of typical assets 1102 in organizations include but are not limited to devices 1110, software 1112, services 1114, among others, such as firewalls, databases etc. Typical artifacts 1104 include but are not limited to procedures 1116, fragments 1118, evidences 1120, configurations 1122, among others. The data structure 1008 has two levels to accommodate the structure of the assets 1102 and the artifacts 1104 to the actual distribution within the organization. Several assets 1102 from a specification point of view could be referring to the one real asset within the organization. This is represented by the organizational assets 1106 and the organizational artifacts 1108 blocks in essence creating a hierarchy of assets 1102 and artifacts 1104 that are linked to the organizational assets 1106 and organizational artifacts 1108.

FIG. 12 illustrates a high level view of an event compliance correlation system 614 according to one embodiment. As illustrated in FIG. 12, the event compliance correlation system 614 employs sources such as system logs 1202, system configuration parameters 1204, and inputs from third party assessment tools 1206 to match the output to control breaches. The output from the data feed connector sources 1202, 1204, 1206 are provided to a data aggregator/normalization process 1206 and then to a process for analyzing normalized breaches of data 1210.

At the system logs 1202 data feed connector source, the event compliance correlation system 614 logs including, but not limited to SIEM, firewalls, routers, network devices, servers, databases etc., are evaluated. Using various techniques (heuristics, pattern recognition, IP address mapping, port mapping etc.) the process 1210 analyzes normalized data for breaches. The breach analysis process 1210 compares and contrasts the input with controls requirements and produce an output that shows control breach(es) and produces controls breach notification in real time, near real time or periodically.

At the system configuration parameters 1204 data feed connector source, the event compliance correlation system 614 will take inputs from various system files including but not limited to operating systems files, database configuration details, firewall rules, router configurations and third party configuration management tools. The system 614 then employs various techniques to perform automated controls testing on configuration files 1210 and will produce an output that controls breach and produces breach notifications in real time, near real time, or periodically.

At the system configuration parameters 1204 data feed connector source, the event compliance correlation system 614 receives output from 3rd party assessment tools including but not limited to security vulnerability scanners, penetration testing tools, patch management tools, configuration management tools, firewall rule analysis tools, network topology tools, CMDB etc. and will employ various techniques to perform controls testing in an automated fashion 1210. The system 614 then produces an output that controls breach and produces controls breach notification in real time, near real time or periodically.

Output with respect to controls failure will be displayed either in the task manager 622 (FIG. 6), or the notification assistant 628. When displayed by the notification assistance 628, the task manager 622 will display the task with appropriate remediation action item that will be routed based on the role mapping 606.

The system will use push and pull methods for data collection. The system will also use other systems for data normalization. The system may or may not have agents running on individual systems for data collections. The system will accept multiple formats of data including but not limited to CSV, XML, structure data, unstructured data etc.

While various details have been set forth in the foregoing description, it will be appreciated that the various embodiments of the system and method for compliance event and incident management may be practiced without these specific details. For example, for conciseness and clarity selected aspects of the system and method have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The appended claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Some or all of the embodiments described herein may generally comprise technologies which can be implemented, individually, and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include--as appropriate to context and application--all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

Various aspects of the subject matter described herein are set out in the following numbered clauses:

1. A system and method for specification patternization comprising the ability to take specific standards, compliance regulations, process specifications, notification regulations, and audit reporting instructions to parameterize the regulation or requirement parameters. The system and method comprising:

Regulation parameters extracted from the specific standards, compliance regulations, process specifications, notification regulations, and audit reporting requirements.

A task pattern registry being a repository that houses predefined patterns based on prior patternization. The registry is accessed when there is a need for a new pattern or to add new patterns.

New task patterns are created if no match is found within the task pattern registry using a unique method.

A roles and responsibilities index is created that defines typical roles against the regulation parameters. These are subsequently mapped to the organization roles.

A process constructor creating machine processable processes based on input from regulation parameters, the roles and responsibilities index, and the task pattern registry.

The generation of machine processable processes that subsequently support compliance processes, notification processes, and audit processes.

Business process artifacts being created in an automated way based on a set of automated parameterized task patterns and fed into a process engine (BPMN).

2. A system and method of creating task patterns. The patterns are structured with predefined information with segments of the pattern changing based on the task. A collection of patterns has been created and these have found to be repeatable across processes and regulatory requirements. The method comprising:

Identifying the input needed to complete the tasks. The inputs being in the form of assets, artifacts, or both.

Identifying the outputs generated from the task. The outputs being in the form of assets, artifacts, or both.

Identifying the standardized or static elements of the pattern.

Identifying the segment or specification for the variable or dynamic text is defined. Generally this is based on regulation requirements.

3. An system and method for adaptive process orchestration based on organizational structure using the following methods:

Compliance events based on time based triggers. These are modifiable by the user in most cases. They ultimately define when the task will be regenerated or generated for the first time. First time configuration tasks are predefined in the system.

Environmental triggers including changes to any of the input specifications, regulations or instructions.

Data dependencies that process generation or regeneration of tasks and related processes. As one of the related inputs or outputs is modified, all related or unrelated activity that feature the modified article are regenerated.

Analytical event processing mechanism which raise alerts from security or system events by reinterpreting them from a compliance perspective.

4. The system and method of claim 3, comprising the creation of process parameters to create a set of tasks linked together with a certain structure.

The parameters will orchestrate the sequence of the tasks to create a process. The sequence may be parallel, sets of tasks sequence, or loops in the task may be defined. The process constructor is responsible for creating the process and link the flow of tasks. The Process constructor uses as inputs the created regulation parameters, and task patterns combined to create processes that satisfy the requirements within the regulations.

5. A system and method that performs compliance event correlation. The system using compliance events to analyze security events.

Security events and data from system logs, system configuration parameters and input from third party assessment tools are used to match the output to control breaches.

The compliance events from the correlation system are linked to the process engine facilitating new tasks related to the event.

6. A system and method for regulatory notification management. The ability to enter into obligatory agreements that go beyond the scope of the service level agreement with specific intent to trigger notification on regulation compliance and performance, including regulatory breeches.

7. The system for regulatory notification management providing the mechanism by which regulatory notifications agreements are created and used for reporting on regulation compliance and performance, including regulatory breeches. It includes the following methods.

Input from the notification regulations that specifies requirements by State, country or entity to be informed. These are parameterized into regulation parameters.

The parameters from the regulatory notification agreements that define the terms for notification.

The notification assistant provides breach notification management based on either alarms from correlation events or alarms from the regulatory notification management system to regulatory agencies, government entities, third parties etc. based on the notification requirements.

8. A system and method for an evidence manager that creates high quality relevant evidences based on audit reporting instructions or other requirements

9. A system and method for encoding video stream for evidencing purposes that may contain sensitive information at the server or the client.

10. A system and method from above that stores evidences in the evidence registry, which may be accessed by task or process to provide auditors, third parties or the enterprise evidence for said activities.

11. A system and method for capturing high quality video for evidencing purpose that uses limited space and significantly reduces the space requirements for such evidence capture.

12. A system and method of claim 7 that uses the help assistant to guide the user on what activities to undertake during the evidencing process to create a high quality evidence that supports the audit reporting instructions for that task.

13. An audit management system and method that uses the following methods:

Ability to generate sampling on a per task basis. The sampling requirements based on the audit reporting instructions and other specification requirements.

An ability to generate test audits within the process.

Ability to generate audit check list.

Ability to score test audits.

1. A method for specification patternization having the ability to take specific standards, compliance regulations, process specifications, notification regulations, and audit reporting instructions to parameterize the regulation or requirement parameters, the method comprising:
extracting regulation parameters from the specific standards, compliance regulations, process specifications, notification regulations, and audit reporting requirements;
accessing a task pattern registry when there is a need for a new pattern or to add new patterns, where in the task pattern registry is a repository that houses predefined patterns based on prior patternization;
creating a task pattern when no match is found within the task pattern registry using a unique method;
creating a roles and responsibilities index that defines roles against the regulation parameters and mapping the roles into organization roles;
creating a machine processable process by a process constructor based on input from regulation parameters, the roles and responsibilities index, and the task pattern registry;
generating a machine processable process to support compliance processes, notification processes, and audit processes; and
creating business process artifacts in an automated way based on a set of automated parameterized task patterns and fed into a process engine (BPMN).

2. The method of claim 1, wherein creating a task pattern comprises:
structuring the task pattern with predefined information with segments of the task pattern changing based on the task; and
creating a collection of task patterns that have found to be repeatable across processes and regulatory requirements, comprising:
identifying an input needed to complete the task patterns, wherein the input is in the form of any one of assets, artifacts, or both;
identifying an output generated from the task patterns, wherein the output is in the form of assets, artifacts, or both;
identifying standardized or static elements of the pattern; and
identifying a segment or specification for a variable or dynamic text that is defined.

3. An adaptive method for process orchestration based on organizational structure, the method comprising:
triggering compliance events based on time based triggers, wherein the time based triggers are modifiable by a user;
defining when a task will be regenerated or generated for the first time;
triggering environmental change including changes to any one of input specifications, regulations, and instructions;
processing by data dependencies generation or regeneration of tasks and related processes;
regenerating all related or unrelated activity that feature a modified article when one of a related input or output is modified; and
processing an analytical event mechanism which raises alerts from security or system events by reinterpreting them from a compliance perspective.

4. The method of claim 3, comprising:
creating by a process constructor process parameters to create a set of tasks linked together with a certain structure, wherein the process parameters orchestrate a sequence of the tasks to create a process.

5. The method of claim 4, wherein the sequence is any one of a parallel sequence, a set of tasks sequence, and loops in the task.

6. The method of claim 4, comprising satisfying requirements within regulations by processes created by the process constructor using as inputs combined created regulation parameters and task patterns.

7. A system to perform compliance event correlation, the system using compliance events to analyze security events, the system comprising security events and data from system logs, system configuration parameters and input from third party assessment tools are used to match the output to control breaches.

8. The system of claim 7, wherein a plurality of compliance events from a correlation system are linked to a process engine facilitating new tasks related to the compliance event.

9. A method for regulatory notification management in a system for regulatory notification management providing the mechanism by which regulatory notifications agreements are created and used for reporting on regulation compliance and performance, including regulatory breeches, the method comprising:
entering into obligatory agreements that go beyond the scope of the service level agreement; and
triggering notification on regulation compliance and performance, including regulatory breeches.

10. The method of claim 9, comprising receiving inputs from the notification regulations that specifies requirements by State, country or entity to be informed, wherein the inputs are parameterized into regulation parameters.

11. The method of claim 10, defining terms for notification based on the regulation parameters from the regulatory notification agreements.

12. The method of claim 9, comprising providing by a notification assistant breach notification management based on either alarms from correlation events or alarms from the regulatory notification management system to at least one of regulatory agencies, government entities, and third parties based on the notification requirements.

13. A method for an evidence manager, the method comprising creating relevant evidences based on audit reporting instructions or other requirements.

14. The method of claim 13, comprising encoding video stream for evidencing purposes that may contain sensitive information at a server or a client.

15. The method of claim 14, comprising storing evidences in an evidence registry, accessable by a task or process to provide auditors, third parties or the enterprise evidence for the activities.

16. The method of claim 14, comprising capturing high quality video for evidencing purpose that uses limited space and significantly reduces storage space requirements for such evidence capture.

17. The method of claim 16, comprising guiding a user by a help assistant on what activities to undertake during an evidencing process to create a high quality evidence that supports audit reporting instructions for a task.

18. An audit management method, comprising generating sampling on a per task basis with wherein sampling requirements based on audit reporting instructions and specification requirements.

19. The method of claim 18, comprising generating test audits within a process.

20. The method of claim 18, comprising generating an audit check list.

21. The method claims 18, comprising scoring test audits.
